(19) United States
(12) Patent Application Publication
(10) Pub. No.: US 2023/0212389 A1
(43) Pub. Date: Jul. 6, 2023

(54) FLAME-RETARDANT POLYCARBONATE COMPOSITION

(71) Applicant: Covestro Deutschland AG, Leverkusen (DE)

(72) Inventors: Qing Guo, Xuhui District, Shanghai (CN); Hao Han, Pudong District, Shanghai (CN); Shoujun Li, Minhang District, Shanghai (CN); Zhenyu Huang, Pudong New District, Shanghai (CN)

(21) Appl. No.: 17/996,355

(22) PCT Filed: May 5, 2021
(86) PCT No.: PCT/EP2021/061788

§ 371 Date: Oct. 17, 2022

(30) Foreign Application Priority Data
May 13, 2020 (WO) PCT/CN2020/089953
Jun. 5, 2020 (EP) 20178399.0

(51) Int. Cl. C08L 69/00; C08L 33/12; C08L 85/02; C08K 7/14; C08L 27/18

(52) U.S. Cl. CPC C08L 69/00; C08L 33/12; C08L 85/02; C08K 7/14; C08L 27/18; C08L 2201/02

(57) ABSTRACT

The present invention relates to a flame-retardant polycarbonate composition comprising the following components:

A) 50-90 parts by weight of aromatic polycarbonate,
B) 3-20 parts by weight of non-core-shell impact modifier,
C) 2-15 parts by weight of at least one cyclic phosphazene of formula (V):

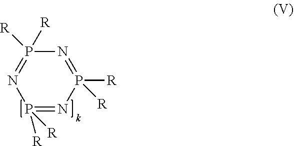

where
k is an integer from 1 to 10, the trimer content (k=1) being more than 98 mol %, based on component C, and where
R are in each case identical or different and are an amine radical, C₁-C₈-alkyl in each case optionally halogenated, C₁-C₈-alkoxy, C₅-C₆-cycloalkyl in each case optionally substituted by alkyl and/or halogen, C₆-C₂₀-aryloxy in each case optionally substituted by alkyl and/or halogen, and/or hydroxyl, C₇-C₁₂-aralkyl in each case optionally substituted by alkyl and/or halogen, a halogen radical, or an OH radical,
D) 0-30 parts by weight of filler,
E) 0.05-5 parts by weight of antidripping agent; and
F) 0-15 parts by weight of additional additives,
the total weight of the composition is 100 parts by weight,
preferably, the composition consists to at least 90 wt. %, more preferably at least 95 wt. %, most preferably 100 wt % of components A-F, relative to the total weight of the composition.

The present invention also relates to a shaped article produced from the composition. The polycarbonate composition according to the present invention has a good combination of flame retardancy, hydrolytic stability and impact resistance, meanwhile there is no feeding issue during its production.

### TECHNICAL FIELD

The present invention relates to a flame-retardant polycarbonate (PC) composition, and a shaped article produced from the same.

### BACKGROUND ART

Polycarbonate compositions have been known for a long time, and these materials are used to produce moulded articles for a wide variety of applications. For some applications, flame retardancy is necessary. Cyclic phosphazenes are excellent flame retardant commonly used in polycarbonate compositions.

US 2016/0185956 A1 discloses polycarbonate/acrylonitrile-butadiene-styrene (ABS) compositions containing at least one cyclic phosphazene, wherein the content of trimer cyclic phosphazene is from 60-98 mol % based on the at least one cyclic phosphazene, the compositions have good mechanical properties, good chemical resistance and high hydrolytic stability. However, the amount of cyclic phosphazene is below than 5 wt. % base on the total weight of PC compositions, due to feeding issues.

EP 1196498 A1 discloses moulding compositions containing phosphazenes and based on polycarbonate and graft polymers selected from the group of the silicone, EP(D)M and acrylate rubbers as graft base, the compositions have excellent flame retardancy and very good mechanical properties such as stress cracking resistance or notched impact strength.

EP 1095100 A1 discloses polycarbonate/ABS compositions comprising phosphazenes and inorganic nanoparticles, the compositions have excellent flame retardancy and very good mechanical properties.

EP 1095097 A1 discloses polycarbonate/ABS compositions comprising phosphazenes and a graft polymer, the compositions have excellent flame retardancy and very good processing properties, wherein the graft polymer is produced by means of mass, solution or mass-suspension polymerization processes.

US 2003/040643 A1 discloses a process for the preparation of phenoxyphosphazenes, as well as polycarbonate/ABS moulding compositions comprising the phenoxyphosphazenes.

The moulding compositions have good flame retardancy, good flowability, good impact strength and high heat distortion resistance.

US 2003/092802 A1 discloses phenoxyphosphazenes, as well as their preparation and use in polycarbonate/ABS moulding compositions. The phenoxyphosphazenes are preferably crosslinked, and the moulding compositions are characterized by good flame retardancy, good impact strength, a high bending modulus and a high melt volume-flow rate. The ABS used is not described in detail. Moreover, the contents of trimers, tetramers and higher oligomers of the present application are not described in this document.

JP 2004 155802 discloses cyclic phosphazenes and their use in thermoplastic moulding compositions such as polycarbonate and ABS. Polycarbonate/ABS moulding compositions comprising cyclic phosphazenes with precisely defined contents of trimers, tetramers and higher oligomers are not disclosed.

The cyclic phosphazene currently used in PC compositions compounding process has feeding issues. For example, it is easy to block the inlet of an extruder if the inlet temperature is higher than 80° C., especially when the content of filler in the PC composition is high, and the screw used in the production line would be damaged. Cyclic phosphazene as flame retardant agent cannot be fed separately.

Thus, there is still a need to provide a polycarbonate composition which has a good combination of flame retardancy, hydrolytic stability and mechanical properties such as impact resistance, meanwhile there is no feeding issue in its production.

### SUMMARY OF THE INVENTION

One object of the present application is thus to provide a polycarbonate composition which has good combination of flame retardancy, hydrolytic stability and impact resistance, meanwhile there is no feeding issue in its production.

Therefore, according to a first aspect, the present invention provides a flame-retardant polycarbonate (PC) composition comprising the following components:

A) 50-90 parts by weight of aromatic polycarbonate,

B) 3-20 parts by weight of non-core-shell impact modifier,

C) 2-15 parts by weight of at least one cyclic phosphazene of formula (V):

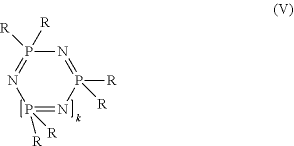

where

k is an integer from 1 to 10, preferably a number from 1 to 8 and particularly preferably 1 to 5,

the trimer content (k=1) being more than 98 mol %, based on component C,

and where

R are in each case identical or different and are an amine radical, C₁-C₈-alkyl in each case optionally halogenated, preferably with fluorine, preferably methyl, ethyl, propyl or butyl, C₁-C₈-alkoxy, preferably methoxy, ethoxy, propoxy or butoxy, C₅-C₆-cycloalkyl in each case optionally substituted by alkyl, preferably C₁-C₄-alkyl, and/or halogen, preferably chlorine and/or bromine, C₆-C₂₀-aryloxy in each case optionally substituted by alkyl, preferably C₁-C₄-alkyl, and/or halogen, preferably chlorine or bromine, and/or hydroxyl, preferably phenoxy or naphthyloxy, C₇-C₁₂-aralkyl in each case optionally substituted by alkyl, preferably C₁-C₄-alkyl, and/or halogen, preferably chlorine and/or bromine, preferably phenyl-C₁-C₄-alkyl, a halogen radical, preferably chlorine, or an OH radical,

D) 0-30 parts by weight of filler,

E) 0.05-5 parts by weight of anti-dripping agent; and

F) 0-15 parts by weight of additional additives,

the total weight of the composition is 100 parts by weight,

preferably, the composition consists to at least 90 wt. %, more preferably at least 95 wt. %, most preferably 100 wt % of components A-F, relative to the total weight of the composition.

According to a second aspect, the present invention provides a shaped article made from the polycarbonate composition according to the first aspect of the present invention.

According to a third aspect, the present invention provides a process for preparing the shaped article according to the second aspect of the present invention, comprising injection moulding, extrusion moulding, blowing moulding or thermoforming the polycarbonate composition according to the first aspect of the present invention.

According to a fourth aspect, the present invention provides use of at least one cyclic phosphazene of formula (V):

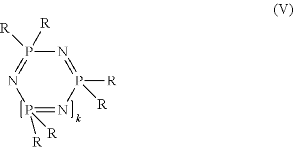

wherein

k is 1 or an integer from 1 to 10, preferably a number from 1 to 8 and particularly preferably 1 to 5,

the trimer content (k=1) being more than 98 mol %, based on the at least one cyclic phosphazenes,

and wherein

R are in each case identical or different and are an amine radical, C₁-C₈-alkyl in each case optionally halogenated, preferably with fluorine, preferably methyl, ethyl, propyl or butyl, C₁-C₈-alkoxy, preferably methoxy, ethoxy, propoxy or butoxy, C₅-C₆-cycloalkyl in each case optionally substituted by alkyl, preferably C₁-C₄-alkyl, and/or halogen, preferably chlorine and/or bromine, C₆-C₂₀-aryloxy in each case optionally substituted by alkyl, preferably C₁-C₄-alkyl, and/or halogen, preferably chlorine or bromine, and/or hydroxyl, preferably phenoxy or naphthyloxy, C₇-C₁₂-aralkyl in each case optionally substituted by alkyl, preferably C₁-C₄-alkyl, and/or halogen, preferably chlorine and/or bromine, preferably phenyl-C₁-C₄-alkyl, a halogen radical, preferably chlorine, or an OH radical for preparation of a flame-retardant polycarbonate composition with increased hydrolysis stability.

The polycarbonate composition according to the present invention has a good combination of flame retardancy, hydrolytic stability and impact resistance, meanwhile there is no feeding issue in its production. In addition, the processing window in term of temperature could be broader for the polycarbonate composition according to the present invention.

The polycarbonate composition according to the present invention has a flame-retardent rate of VO even with a lower thickness, for example, 1.5 mm, as measured in accordance with UL94: 2015.

Other subjects and characteristics, aspects and advantages of the present invention will emerge even more clearly on reading the description and the examples that follows.

### DETAILED DESCRIPTION OF THE INVENTION

In that which follows and unless otherwise indicated, the limits of a range of values are included within this range, in particular in the expressions “between . . . and . . . ” and “from . . . to . . . ”.

Throughout the present application, the term “comprising” is to be interpreted as encompassing all specifically mentioned features as well optional, additional, unspecified ones.

Unless defined otherwise, all technical and scientific terms used herein have the same meaning as commonly understood by one of ordinary skill in the art to which the present invention pertains. When the definition of a term in the present description conflicts with the meaning as commonly understood by those skilled in the art the present invention belongs to, the definition described herein shall apply.

Unless otherwise specified, all numerical values expressing amount of ingredients and the like which are used in the description and claims are to be understood as being modified by the term “about”.

All percentages in the present application refer to weight percentage, unless otherwise specified.

Technical features described for each element in the present application can combined in any way on the provision that there is no conflict.

Component A

According to the first aspect, the polycarbonate composition according to the present invention comprises an aromatic polycarbonate as component A.

Aromatic polycarbonates that are suitable according to the invention as component A are known in the literature or can be prepared by processes known in the literature (for the preparation of aromatic polycarbonates see e.g. Schnell, “Chemistry and Physics of Polycarbonates”, Interscience Publishers, 1964, and DE-AS 1 495 626, DE-A 2 232 877, DE-A 2 703 376, DE-A 2 714 544, DE-A 3 000 610, DE-A 3 832 396; and DE-A 3 007 934).

Aromatic polycarbonates are prepared e.g. by reacting diphenols with carbonic acid halides, preferably phosgene, and/or with aromatic dicarboxylic acid dihalides, preferably benzenedicarboxylic acid dihalides, by the phase interface process, optionally using chain terminators, e.g. monophenols, and optionally using trifunctional or more than trifunctional branching agents, e.g. triphenols or tetraphenols. They can also be prepared by reacting diphenols with e.g. diphenyl carbonate by a melt polymerization process.

Diphenols for the preparation of the aromatic polycarbonates are preferably those of formula (I):

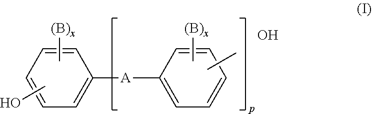

wherein

A is a single bond, C₁-C₅-alkylene, C₂-C₅-alkylidene, C₅-C₆-cycloalkylidene, —O—, —SO—, —CO—, —S—, —SO₂—, C₆-C₁₂-arylene to which further aromatic rings optionally containing heteroatoms can be fused,
or a radical of formula (II) or (III):

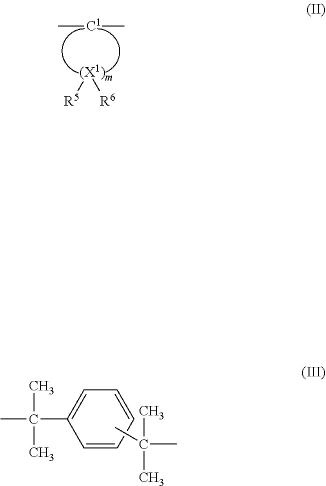

B are in each case C₁-C₁₂-alkyl, preferably methyl, or halogen, preferably chlorine and/or bromine,

x independently of one another are in each case 0, 1 or 2,

p is 1 or 0, and

R⁵ and R⁶ can be individually chosen for each X¹ and independently of one another are hydrogen or C₁-C₆-alkyl, preferably hydrogen, methyl or ethyl,

X¹ is carbon, and

m is an integer from 4 to 7, preferably 4 or 5,

with the proviso that R⁵ and R⁶ are simultaneously alkyl on at least one atom X¹.

Preferred diphenols are hydroquinone, resorcinol, dihydroxydiphenols, bis(hydroxy-phenyl)-C₁-C₅-alkanes, bis(hydroxyphenyl)-C₅-C₆-cycloalkanes, bis(hydroxyphenyl) ethers, bis(hydroxyphenyl) sulfoxides, bis(hydroxyphenyl) ketones, bis(hydroxyphenyl) sulfones and α,α-bis(hydroxyphenyl)diisopropylbenzenes, and their ring-brominated and/or ring-chlorinated derivatives.

Particularly preferred diphenols are 4,4′-dihydroxydiphenyl, bisphenol A, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclohexane, 4,4′-dihydroxydiphenyl sulfide, 4,4′-dihydroxydiphenyl sulfone and their di- and tetrabrominated or chlorinated derivatives, e.g. 2,2-bis(3-chloro-4-hydroxyphenyl)propane, 2,2-bis(3,5-dichloro-4-hydroxyphenyl)propane or 2,2-bis(3,5-dibromo-4-hydroxyphenyl)propane, 2,2-Bis(4-hydroxyphenyl)propane (bisphenol A) is particularly preferred.

The diphenols can be used individually or as any desired mixtures. The diphenols are known in the literature or obtainable by processes known in the literature.

Examples of suitable chain terminators for the preparation of the thermoplastic aromatic polycarbonates are phenol, p-chlorophenol, p-tert-butylphenol or 2,4,6-tribromophenol, as well as long-chain alkylphenols such as 4-[2-(2,4,4-trimethylpentyl)]phenol and 4-(1,3-tetramethylbutyl)phenol according to DE-A 2 842 005, or monoalkylphenols or dialkylphenols having a total of 8 to 20 carbon atoms in the alkyl substituents, such as 3,5-ditert-butylphenol, p-isooctylphenol, p-tert-octylphenol, p-dodecylphenol, 2-(3,5-dimethylheptyl)phenol and 4-(3,5-dimethylheptyl)phenol. The amount of chain terminators to be used is generally between 0.5 mol % and 10 mol %, based on the molar sum of the particular diphenols used.

The thermoplastic aromatic polycarbonates can be branched in known manner, preferably by the incorporation of 0.05 to 2.0 mol %, based on the sum of the diphenols used, of trifunctional or more than trifunctional compounds, e.g. those with three or more phenolic groups.

Both homopolycarbonates and copolycarbonates are suitable. Copolycarbonates according to the invention as component A can also be prepared using 1 to 25 wt %, preferably 2.5 to 25 wt % (based on the total amount of diphenols to be used), of polydiorganosiloxanes with hydroxyaryloxy end groups. These are known and can be prepared by processes known in the literature, see, for example, U.S. Pat. No. 3,419,634). Copolycarbonates comprising polydiorganosiloxanes are also suitable; the preparation of copolycarbonates comprising polydiorganosiloxanes is described e.g. in DE-A 3 334 782.

Aromatic dicarboxylic acid dihalides for the preparation of aromatic polycarbonates are preferably the diacid dichlorides of isophthalic acid, terephthalic acid, diphenyl ether 4,4′-dicarboxylic acid and naphthalene-2,6-dicarboxylic acid.

Mixtures of the diacid dichlorides of isophthalic acid and terephthalic acid in a ratio of between 1:20 and 20:1 are particularly preferred.

A carbonic acid halide, preferably phosgene, is additionally used concomitantly as a difunctional acid derivative in the preparation of polycarbonates.

Suitable chain terminators for the preparation of the aromatic polycarbonates, apart from the monophenols already mentioned, are their chlorocarbonic acid esters and the acid chlorides of aromatic monocarboxylic acids which can optionally be substituted by C₁-C₂₂-alkyl groups or halogen atoms, as well as aliphatic C₂-C₂₂-monocarboxylic acid chlorides.

The amount of chain terminators is 0.1 to 10 mol % in each case, based on moles of diphenol for phenolic chain terminators and on moles of dicarboxylic acid dichloride for monocarboxylic acid chloride chain terminators.

One or more aromatic hydroxycarboxylic acids can additionally be used in the preparation of aromatic polycarbonates.

The aromatic polycarbonates can be both linear and branched in known manner (cf. DE-A 2 940 024 and DE-A 3 007 934 in this connection), linear polycarbonates being preferred.

Examples of branching agents which can be used are trifunctional or more than trifunctional carboxylic acid chlorides such as trimesic acid trichloride, cyanuric acid trichloride, benzophenone-3,3′,4,4′-tetracarboxylic acid tetrachloride, naphthalene-1,4,5,8-tetracarboxylic acid tetrachloride or pyromellitic acid tetrachloride, in amounts of 0.01 to 1.0 mol % (based on the dicarboxylic acid dichlorides used), or trifunctional or more than trifunctional phenols such as phloroglucinol, 4,6-dimethyl-2,4,6-tri(4-hydroxyphenyl)-2-heptene, 4,6-dimethyl-2,4,6-tri(4-hydroxyphenyl)heptane, 1,3,5-tri(4-hydroxyphenyl)benzene, 1,1,1-tri(4-hydroxyphenyl)-ethane, tri(4-hydroxyphenyl)phenylmethane, 2,2-bis[4,4-bis(4-hydroxyphenyl)-cyclohexyl]propane, 2,4-bis(4-hydroxyphenylisopropyl)phenol, tetra(4-hydroxy-phenyl)methane, 2,6-bis(2-hydroxy-5-methylbenzyl)-4-methylphenol, 2-(4-hydroxyphenyl)-2-(2,4-dihydroxyphenyl)propane, tetra(4-[4-hydroxyphenylisopropyl]phenoxy) methane or 1,4-bis[4,4′-(dihydroxytriphenyl)methyl]benzene, in amounts of 0.01 to 1.0 mol %, based on the diphenols used. Phenolic branching agents can be used with the diphenols; acid chloride branching agents can be introduced together with the acid dichlorides.

The proportion of carbonate structural units in the thermoplastic aromatic polycarbonates can vary freely. The proportion of carbonate groups is preferably up to 100 mol %, especially up to 80 mol % and particularly preferably up to 50 mol %, based on the sum of the ester groups and carbonate groups. Both the ester part and the carbonate part of the aromatic polycarbonates can be present in the polycondensation product in the form of blocks or as a random distribution.

The polycarbonates used are preferably linear and more preferably based on bisphenol A.

The aromatic polycarbonates have weight-average molecular weights (M_{w}, measured by GPC (gel permeation chromatography) with polycarbonate based on bisphenol A as standard) of 15,000 to 80,000 g/mol, preferably of 20,000 to 32,000 g/mol, more preferably of 23,000 to 28,000 g/mol and even more preferably of 24,000 to 26,000 g/mol.

As an example of aromatic polycarbonate suitable for the present invention, mention can be made to that sold under the name of Makrolon® 2600 by Covestro Co., Ltd.

The aromatic polycarbonates can be used on their own or in any desired mixture.

Advantageously, the aromatic polycarbonates is present in the polycarbonate composition in an amount ranging from 60 to 85 parts by weight, preferably from 65 to 85 parts by weight, based on the total weight of the polycarbonate composition being 100 parts by weight.

Component B

According to the first aspect, the polycarbonate composition according to the present invention comprises an non-core shell impact modifier as component B.

As non-core-shell impact modifiers, mention can be made to ethylene acrylate copolymer.

Ethylene Acrylate Copolymer

Preferably, the ethylene acrylate copolymer is an ethylene-alkyl (meth)acrylate copolymer of the formula (IV),

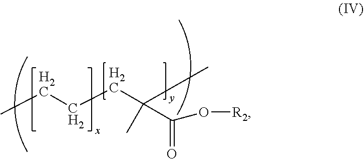

wherein

R₁ is methyl or hydrogen,

R₂ is hydrogen or a C₁-C₁₂-alkyl, preferably methyl, ethyl, propyl, isopropyl, butyl, sec-butyl, tert-butyl, isobutyl, hexyl, isoamyl, or tert-amyl,

each of x and y is an independent degree of polymerization, and

n is an integer >=1.

x and y are independently from each other, being an integer.

The ratios of the degrees of polymerization x and y are preferably in the range x:y=from 300:1 to 10:90.

In some embodiment, x and y are independently from each other, being from 10 to 10,000.

In some embodiment, x and y are independently from each other, being from 50 to 5,000.

The ethylene-alkyl (meth)acrylate copolymer can be a random, block or multiblock copolymer or a mixture of the said structures. In one preferred embodiment, branched and unbranched ethylene-alkyl (meth)acrylate copolymer, particularly linear ethylene-alkyl (meth)acrylate copolymer, is used.

Preferably, component B is ethylene-methyl acrylate copolymer or, alternatively, ethylene-methyl acrylate copolymer is one of the components B. For example, the component B is selected from ethylene acrylate copolymers including Elvaloy® AC1820, AC1224, AC1125, AC1330 from Dupont, and Lotyl® 18MA02, 20MA08, 24MA02, 24MA005, 29MA03, 30BA02, 35BA40, 17BA04, 17BA07 etc. from Arkema.

The melt flow rate (MFR) of the ethylene-alkyl (meth)acrylate copolymer (measured at 190° C. for 2.16 kg load, ASTM D1238-2010) is preferably in the range from 0.5 to 40.0 g/(10 min.), particularly preferably in the range from 0.5 to 15.0 g/(10 min.), most particularly preferably in the range from 2.0 to 12.0 g/(10 min).

It was found that, as compared with core-shell impact modifier, when the non-core-shell impact modifier was used as an impact modifier in the composition according to the present invention, the retention ratio of stiffness of an article prepared from the composition is relative higher after hydrolysis thereof, thus the article could be used in outdoor application.

Advantageously, the impact modifier is present in the polycarbonate composition in an amount ranging from 3 to 15 parts by weight, preferably from 3 to 12 parts by weight, based on the total weight of the polycarbonate composition being 100 parts by weight.

Component C

According to the first aspect, the polycarbonate composition according to the present invention comprises at least one cyclic phosphazene as component C.

Cyclic phosphazenes which are used according to the present invention are cyclic phosphazenes of formula (V):

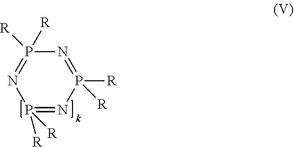

wherein

k is an integer from 1 to 10, preferably a number from 1 to 8 and particularly preferably 1 to 5

the trimer content (k=1) being more than 98 mol %, based on component C,

and wherein

R are in each case identical or different and are
an amine radical,
C₁-C₅-alkyl in each case optionally halogenated, preferably with fluorine and more preferably monohalogenated, preferably methyl, ethyl, propyl or butyl,
C₁-C₈-alkoxy, preferably methoxy, ethoxy, propoxy or butoxy,
C₅-C₆-cycloalkyl in each case optionally substituted by alkyl, preferably C₁-C₄-alkyl, and/or halogen, preferably chlorine and/or bromine,
C₆-C₂₀-aryloxy in each case optionally substituted by alkyl, preferably C₁-C₄-alkyl, and/or halogen, preferably chlorine or bromine, and/or hydroxyl, preferably phenoxy or naphthyloxy,
C₇-C₁₂-aralkyl in each case optionally substituted by alkyl, preferably C₁-C₄-alkyl, and/or halogen, preferably chlorine and/or bromine, preferably phenyl-C₁-C₄-alkyl, or
a halogen radical, preferably chlorine or fluorine, or
an OH radical.

The phosphazenes and their preparation are described e.g. in EP-A 728 811, DE-A 1 961 668 and WO 97/40092.

The following are preferred: propoxyphosphazene, phenoxyphosphazene, methylphenoxyphosphazene, aminophosphazene and fluoroalkylphosphazenes, as well as phosphazenes of the following structures:

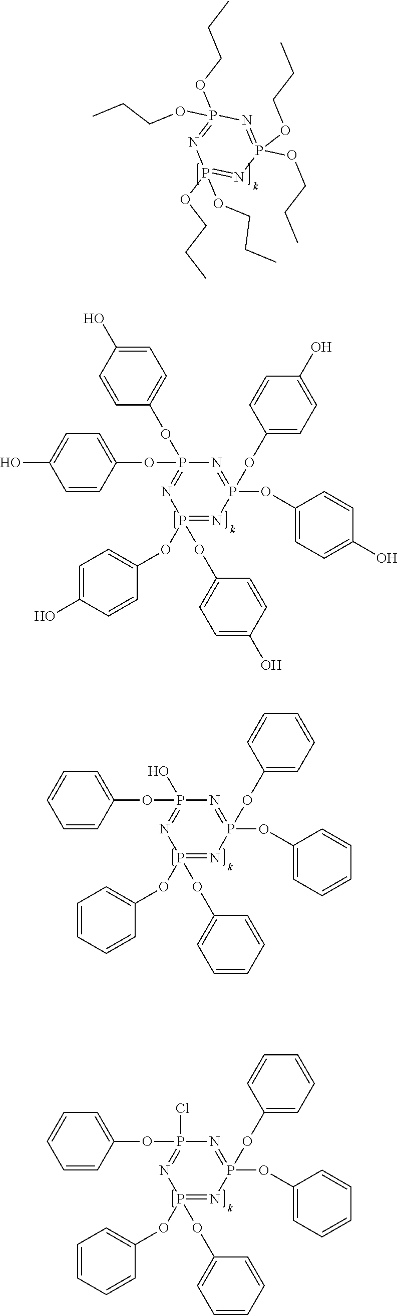

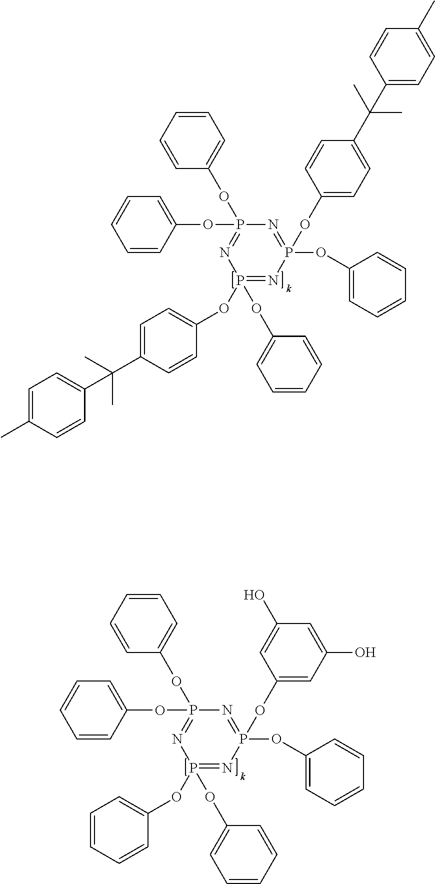

In the compounds shown above, k=1, 2 or 3.

Preferably, the trimer content (k=1) is from 98.5 to 100 mol %, preferably from 99 to 100 mol %, based on component C.

In the case where the phosphazene of formula (V) is halogen-substituted on the phosphorus, e.g. from incompletely reacted starting material, the proportion of this phosphazene halogen-substituted on the phosphorus is preferably less than 1000 ppm, more preferably less than 500 ppm.

The phosphazenes can be used on their own or as a mixture, i.e. the radicals R can be identical or 2 or more radicals in formula (V) can be different. Preferably, the radicals R of a phosphazene are identical.

In a more preferred embodiment, only phosphazenes with identical R are used.

Preferably, all R=phenoxy.

The most preferred compound is phenoxyphosphazene of formula (VI) (all R=phenoxy) with an oligomer content where k=1 (C1) of 98.5-100 mol %, preferably 99-100 mol %.

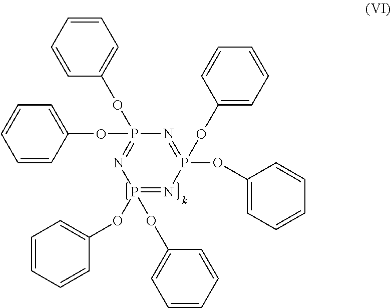

The oligomer compositions of the phosphazenes in the respective blend samples can also be detected and quantified, after compounding, by ³¹P-NMR (chemical shift; δ trimer: 6.5 to 10.0 ppm; δ tetramer: −10 to −13.5 ppm; δ higher oligomers: −16.5 to −25.0 ppm).

Advantageously, the cyclic phosphazene is present in the polycarbonate composition in an amount ranging from 4 to 18 parts by weight, preferably from 6 to 15 parts by weight, based on the total weight of the polycarbonate composition being 100 parts by weight.

It was also found that the polycarbonate composition containing at least one cyclic phosphazene as defined in the present application has better hydrolysis stability, as compared with a similar polycarbonate composition containing at least one cyclic phosphazene with a low content of trimer cyclic phosphazene.

Component D

According to the first aspect, the polycarbonate composition according to the present invention may comprise a filler.

Fillers suitable for the present invention include mineral fillers and glass fiber, preferably the reinforcement material is mineral filers.

Examples of mineral fillers are mica, talc, wollastonite, barium sulfate, silica, kaolin, titanium dioxide, aluminum hydroxide, magnesium hydroxide, feldspar, asbestos, calcium carbonate, dolomite, vermiculite, attapulgite, bentonite, perlite, pyrophylite or the like.

Preferably, the mineral filler is selected from kaolin, talc, and wollastonite. More preferably, the mineral filler is selected from wollastonite and talc.

Preferably, the mineral filler is in platy shape, needle shape or spherical shape.

As examples of mineral filler useful in the polycarbonate composition according to the present invention, mention can be made to Talc HTP® Ultra 5C from IMI Fabi S.p.A., Kaolin Polyfil™ HG90 from KaMin LLC and Wollastonite Nyglos® 4w from Imerys Talc America, Inc.

The glass fiber can be chopped or milled.

Preferably, glass fibers in the form of chopped strands having a length of 1 mm to 6 mm, in particular, 3 mm to 6 mm, are used.

The glass fiber may have a round (or circular), flat, or irregular cross-section. Thus, use of fiber with a non-round cross section is possible.

Preferably, the glass fiber may have a round (or circular) cross-section.

As examples of milled glass fiber useful in the polycarbonate composition according to the present invention, mention can be made to MF 7980 from Lanxess AG Germany and CS3PE937 from Nitto Boseki Co. Ltd. Japan.

Advantageously, the filler is present in the polycarbonate composition in an amount ranging from 0.5 to 30 parts by weight, preferably from 2 to 28 parts by weight, more preferably from 3 to 26 parts by weight, most preferably 10 to 20 parts by weight, based on the total weight of the polycarbonate composition being 100 parts by weight.

It was found that when the composition according to the present invention comprises a filler, the rigidity of an article prepared from the composition was improved, thus the article could be used in certain filed where high modulus is required.

Component E

According to the first aspect, the polycarbonate composition according to the present invention comprises an anti-dripping agent.

Preferably, the anti-dripping agent used is selected from fluorinated polyolefins.

The fluorinated polyolefins are known (see “Vinyl and Related Polymers” by Schildknecht, John Wiley & Sons, Inc., New York, 1962, pages 484494; “Fluoropolymers” by Wall, Wiley-Interscience, John Wiley & Sons, Inc., New York, Volume 13, 1970, pages 623-654; “Modern Plastics Encyclopedia”, 1970-1971, Volume 47, No. 10 A, October 1970, McGraw-Hill, Inc., New York, pages 134 and 774; “Modern Plastics Encyclopaedia”, 1975-1976, October 1975, Volume 52, No. 10 A, McGraw-Hill, Inc., New York, pages 27, 28 and 472 and US-PS 3 671 487, 3 723 373 and 3 838 092).

Preferably, the anti-dripping agent is selected from polytetrafluoroethylene, polyvinylidene fluoride, tetrafluoroethylene/hexafluoropropylene copolymer and ethylene/tetrafluoroethylene copolymer.

More preferably, the anti-dripping agent used is polytetrafluoroethylene (PTFE).

Polytetrafluoroethylene can be prepared by known processes, for example by polymerization of tetrafluoroethylene in an aqueous medium with a free radical-forming catalyst, for example sodium, potassium or ammonium peroxodisulfate, at pressures of from 7 to 71 kg/cm² and at temperatures of from 0 to 200° C., preferably at temperatures of from 20 to 100° C., for further details see e.g. U.S. Pat. No. 2,393,967.

Preferably, the fluorinated polyolefins have a high molecular weight and have glass transition temperatures of over −30° C., generally over 100° C., fluorine contents of preferably from 65 to 76 wt. %, in particular from 70 to 76 wt. % (with the fluorinated polyolefins as 100 wt. %), mean particle diameters d₅₀ of from 0.05 to 1,000 μm, preferably from 0.08 to 20 Jim.

Preferably, the fluorinated polyolefins have a density of from 1.2 to 2.3 g/cm³.

More preferably, the fluorinated polyolefins used according to the invention have mean particle diameters of from 0.05 to 20 μm, preferably from 0.08 to 10 μm, and density of from 1.2 to 1.9 g/cm³.

Suitable fluorinated polyolefins which can be used in powder form are tetrafluoroethylene polymers having mean particle diameters of from 100 to 1000 μm and densities of from 2.0 g/cm 3 to 2.3 g/cm³.

As an example of commercial products of polytetrafluoroethylene, mention can be made to those sold under the trade name Teflon© by DuPont.

A master batch of polytetrafluoroethylene and styrene-acrylonitrile (SAN) in a weight ratio of 1:1, for example, ADS 5000 available from Chemical Innovation Co., Ltd. Thailand and POLYB FS-200 available from Han Nanotech Co., Ltd, can also be used.

Advantageously, the anti-dripping agent is present in the polycarbonate composition according to the present invention in an amount ranging from 0.1 to 1 part by weight, preferably from 0.2 to 0.6 parts by weight, based on the total weight of the polycarbonate composition being 100 parts by weight.

Additional Additives F

In addition to components A-E mentioned above, the polycarbonate composition according to the present invention can optionally comprise a balance amount of one or more additional additives conventionally used in polymer compositions, such as flameproofing synergistic agents apart from antidripping agent mentioned as component E, lubricants and demoulding agents (e.g. pentaerythritol tetrastearate), stabilizers (e.g. UV/light stabilizers, heat stabilizers, antioxidants, antistatic agents (e.g. conductive carbon blacks, carbon fibres, carbon nanotubes and organic antistatic agents such as polyalkylene ethers, alkylsulfonates or polyamide-containing polymers), dyestuffs, pigments, etc.

As stabilizers it is preferable to use sterically hindered phenols and phosphites or mixtures thereof, e.g. Irganox® B900 (Ciba Speciality Chemicals).

The skilled in the art can select the type and the amount of the additional additives so as to not significantly adversely affect the desired properties of the polycarbonate composition according to the present invention.

In some embodiments, the polycarbonate composition according to the present invention is consisted of components A to F.

In some preferred embodiments, the polycarbonate composition is free of inorganic flame retardant and flame-retardant synergistic agents, especially aluminium hydroxide, aluminium oxide-hydroxide and arsenic and antimony oxides.

In some preferred embodiments, the polycarbonate composition is free of organic flameproofing agents other than cyclic phosphazene of formula (V), especially bisphenol A diphosphate oligomers, resorcinol diphosphate oligomers, triphenyl phosphate, octamethylresorcinol diphosphate and tetrabromobisphenol A diphosphate oligocarbonate.

Preparation of the Polycarbonate Composition

The polycarbonate composition according to the present invention can be in the form of, for example, pellets, and can be prepared by a variety of methods involving intimate admixing of the materials desired in the composition.

For example, the materials desired in the composition are first blended in a high speed mixer. Other low shear processes, including but not limited to hand mixing, can also accomplish this blending. The blend is then fed into the throat of a twin-screw extruder via a hopper. Alternatively, at least one of the components can be incorporated into the composition by feeding directly into the extruder at the throat and/or downstream through a side stuffer. Additives can also be compounded into a masterbatch with a desired polymeric resin and fed into the extruder. The extruder is generally operated at a temperature higher than that necessary to cause the composition to flow. The extrudate is immediately quenched in a water batch and pelletized. The pellets can be one-fourth inch long or less as described. Such pellets can be used for subsequent molding, shaping or forming.

Melt blending methods are preferred due to the availability of melt blending equipment in commercial polymer processing facilities.

Illustrative examples of equipment used in such melt processing methods include: co-rotating and counter-rotating extruders, single screw extruders, co-kneaders, and various other types of extrusion equipment.

The temperature of the melt in the processing is preferably minimized in order to avoid excessive degradation of the polymers. It is often desirable to maintain the melt temperature between 230° C. and 350° C. in the molten resin composition, although higher temperatures can be used provided that the residence time of the resin in the processing equipment is kept short.

In some cases, the melting composition exits from a processing equipment such as an extruder through small exit holes in a die. The resulting strands of the molten resin are cooled by passing the strands through a water bath. The cooled strands can be chopped into small pellets for packaging and further handling.

Shaped Articles

The polycarbonate composition according to the present invention can be used, for example for the production of various types of shaped articles.

According to the second aspect, the present invention provides a shaped article made from the polycarbonate composition according to the first aspect of the present invention.

As examples of shaped articles, mention can be made to, for example, films; profiles; all kinds of housing parts, e.g. for domestic appliances such as juice presses, coffee machines and mixers, or for office machines such as monitors, flat screens, notebooks, printers and copiers; sheets; tubes; electrical conduits; windows, doors and other profiles for the building sector (interior and exterior applications); electrical and electronic parts such as switches, plugs and sockets; and body parts or interior trim for commercial vehicles, especially for the motor vehicle sector.

In particular, the shaped article can be any of the following: interior trim for rail vehicles, ships, aeroplanes, buses and other motor vehicles, housings for electrical equipment containing small transformers, housings for information processing and transmission equipment, housings and sheathing for medical equipment, housings for safety devices, moulded parts for sanitary and bath fittings, covering grids for ventilation apertures and housings for garden tools.

Preparation of Shaped Articles

The polycarbonate composition according to the present invention can be processed into shaped articles by a variety of means such as injection moulding, extrusion moulding, blowing moulding or thermoforming to form shaped articles.

Thus, according to the third aspect, the present invention provides a process for preparing the shaped article according to the second aspect of the present invention, comprising injection moulding, extrusion moulding, blowing moulding or thermoforming the polycarbonate composition according to the first aspect of the present invention.

Use of Cyclic Phosphazene

The inventors have discovered unexpectedly that the cyclic phosphazene of formula (V) as defined in the present application can substantially improve the hydrolysis stability of a polycarbonate as compared with other cyclic phosphazenes commonly used in the field of polycarbonate.

Thus, according to the fourth aspect, the present invention provides use of at least one cyclic phosphazene of formula (V):

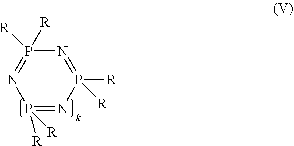

wherein

k is 1 or an integer from 1 to 10, preferably a number from 1 to 8 and particularly preferably 1 to 5,

the trimer content (k=1) being more than 98 mol %, based on the least one cyclic phosphazene,

and wherein

R are in each case identical or different and are an amine radical, C₁-C₈-alkyl in each case optionally halogenated, preferably with fluorine, preferably methyl, ethyl, propyl or butyl, C₁-C₈-alkoxy, preferably methoxy, ethoxy, propoxy or butoxy, C₅-C₆-cycloalkyl in each case optionally substituted by alkyl, preferably C₁-C₄-alkyl, and/or halogen, preferably chlorine and/or bromine, C₆-C₂₀-aryloxy in each case optionally substituted by alkyl, preferably C₁-C₄-alkyl, and/or halogen, preferably chlorine or bromine, and/or hydroxyl, preferably phenoxy or naphthyloxy, C₇-C₁₂-aralkyl in each case optionally substituted by alkyl, preferably C₁-C₄-alkyl, and/or halogen, preferably chlorine and/or bromine, preferably phenyl-C₁-C₄-alkyl, a halogen radical, preferably chlorine, or an OH radical for preparation of a flame-retardant polycarbonate composition with increased hydrolysis stability.

Preferably, all R=phenoxy.

The most preferred compound is phenoxyphosphazene (all R=phenoxy) with an oligomer content where k=1 (C1) of 98.5-100 mol %, preferably 99-100 mol %.

The Examples which follow serve to illustrate the invention in greater detail.

### EXAMPLES

Materials Used

Component A

PC: an aromatic polycarbonate resin having a weight average molecular weight of about 26,000 g/mol produced from bisphenol A and phosgene, available as Makrolon® 2600 from Covestro, Co., Ltd.

Component B
B1: non-core-shell impact modifier, a copolymer of ethylene and methyl acrylate, available as Elvaloy® AC1820 from DuPont de Nemours Switzerland. The melt flow rate (MFR) (measured at 190° C. for 2.16 kg load, ASTM D1238-2010) is 8.0 g/(10 min. B1 has a structure according to formula (IV) and ratio of the degrees of polymerization x and y is in the range x:y=from 300:1 to 10:90.
B2: Styrene-Acrylate Copolymer (SAN) containing 23 wt. % acrylonitrile and 77 wt. % styrene.
B3: core-shell impact modifier of MBS type, KaneAce® M-732 (Kaneka).
B4: a silicone-based core-shell type graft polymer (Graft copolymer having a core-shell structure in which the core is 70 wt % mainly composed of silicone/acrylic composite rubber and the shell is 30 wt % mainly composed of methyl methacrylate, available as Metablen® S2001 from Mitsubishi Rayon Co., Ltd).

Component C
C1: PNZ-1, available as CG-40 from Chembridge Company;
C2: PNZ-2, available as HPCTP from Weihai Jinwei Chem Induxtry Company;
C3: PNZ-3, available as Rabitle© FP-110 from Fushimi Pharmaceutical Company; PNZ-1, PNZ-2 and PNZ-1 are phenoxyphosphazene of formula (VI) with an oligomer content where k=1 of 65 to 100 mol %, and an oligomer content where k≥2 of 0 to 35 mol %.

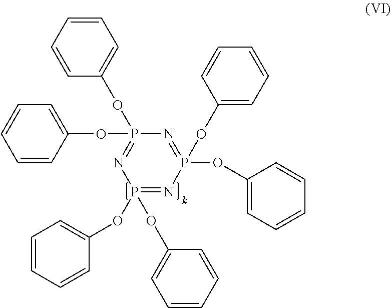

TABLE 1

| | PNZ-1 | PNZ-2 | PNZ-3 |
|---|---|---|---|
| Content where k = 1 (mol. %) | 99.9 | 99.9 | 68 |
| Content where k ≥ 2 (mol. %) | 0.1 | 0.1 | 32 |

Component D
D1: milled glass fiber having a round cross-section, available as CS3PE937 from Nitto Boseki Co. Ltd. Japan.

Component E
E1: a masterbatch of polytetrafluoroethylene and Styrene-Acrylonitrile (SAN) in a weight ratio of 1:1, available as ADS 5000 from Chemical Innovation Co., Ltd. Thailand.

Component F
F1: pentaerythritol tetrastearate (PETS), a demoulding agent, available as Loxiol P 861 from Emery Oleochemicals Sdn Bhd Malaysia;
F2: mixture of 80 wt. % of Irgafos® 168 (tris(2,4-ditert-butylphenyl) phosphite) and 20 wt. % of Irganox® 1076 (2,6-ditert-butyl-4-(octadecanoxycarbonylethyl)phenol, available as Irganox® B900 from BASF (China) Company Limited;
F3: Citric acid, available from Lanxess AG Germany.

Test Methods

The physical properties of compositions obtained in the examples were tested as follows.

The Vicat softening temperature was determined (50N; 120 K/h) in accordance with ISO 306: 2013 on bars of dimensions 80 mm×10 mm×4 mm.

The IZOD notched impact strength was measured on test bars of dimensions 80 mm×10 mm×3 mm or 80 mm×10 mm×4 mm in accordance with ISO 180/IA:2000.

The melt flowability was evaluated by means of the melt volume-flow rate (MVR) measured in accordance with ISO 1133-1: 2011 at a temperature of 260/240° C. and with a die load of 5 kg.

The combustion behavior is measured on 127 mm×12.7 mm bars with 1.0 or 0.75 mm thickness according to UL94-2015.

The hydrolytic stability of the compositions prepared was assessed based on the change in Izod unnotched impact strength measured on 80 mm×10 mm×3 mm or 80 mm×10 mm×4 mm bars in accordance with ISO 180/IA:2000 before and after storage of the bars for 3, 5, 7, and 14 days at 95° C. and 100% relative humidity.

### Invention Examples 1-2 (IE1-IE2) and Comparative Example 1 (CE1)

The materials listed in Table 2 were compounded on a twin-screw extruder (ZSK-25) (Werner and Pfleider) at a speed of rotation of 225 rpm, a throughput of 20 kg/h, and a machine temperature of 260° C., and granulated.

The finished granules are processed into corresponding test specimens on an injection moulding machine with a melting temperature of 260° C. and a mold temperature 80° C.

The materials listed in Table 2 were compounded, the physical properties of compositions obtained were tested and the results were summarized in Table 2.

TABLE 2
Composition and properties of the molding compositions

| Components (parts by weight) | | IE 1 | IE 2 | CE 1 |
|---|---|---|---|---|
| A | PC(Makrolon ®2600) | 66.8 | 66.8 | 66.8 |
| B | B1(Elvaloy AC1820) | 5 | 5 | 5 |
| C | PNZ-2(HPCTP) | 12 | — | — |
| | PNZ-1(CG-40) | — | 12 | — |
| | PNZ-3(FP-110) | — | — | 12 |
| D | D1(CS3PE937) | 15 | 15 | 15 |
| E | E1(ADS 5000) | 0.6 | 0.6 | 0.6 |
| F | F1(Loxiol P 861) | 0.4 | 0.4 | 0.4 |
| | F3(Citric acid) | 0.1 | 0.1 | 0.1 |
| | F2(Irganox B900) | 0.1 | 0.1 | 0.1 |
| | Feeding issue | No | No | Yes |

Properties

| | | | |
|---|---|---|---|
| Vicat softening temperature, 50N/120K/h, [° C.] | 111 | 110 | 109 |
| MVR, 260° C./5 Kg, [cm³/10 min] | 34.8 | 37.8 | 38.4 |
| Izod unnotched impact strength, 23° C./4 mm/11 J, [KJ/m²] | 39 C* | 40 C | 37 C |
| Izod unnotched impact strength after hydrolysis at | 40 C | 37 C | 21 C |
| 95° C./100% RH for 3 days, 23° C./4 mm/11 J, [KJ/m²] | | | |
| Retention ratio of Izod unnotched impact strength after | 102.6% | 92.5% | 56.8% |
| hydrolysis at 95° C./100% RH for 3 days, 23° C./4 mm/11 J, | | | |
| Izod unnotched impact strength after hydrolysis at | 40 C | 39 C | 26 C |
| 95° C./100% RH for 5 days, 23° C./4 mm/11 J, [KJ/m²] | | | |
| Retention ratio of Izod unnotched impact strength after | 102.6% | 97.5% | 70.3% |
| hydrolysis at 95° C./100% RH for 5 days, 23° C./4 mm/11 J, | | | |
| Izod unnotched impact strength after hydrolysis at | 39 C | 36 C | 25 C |
| 95° C./100% RH for 7 days, 23° C./4 mm/11 J, [KJ/m²] | | | |
| Retention ratio of Izod unnotched impact strength after | 100% | 90% | 67.6% |
| hydrolysis at 95° C./100% RH for 7 days, 23° C./4 mm/11 J | | | |
| Izod unnotched impact strength after hydrolysis at | 29 C | 24 C | 19 C |
| 95° C./100% RH for 14 days, 23° C./4 mm/11 J, [KJ/m²] | | | |
| Retention ratio of Izod unnotched impact strength after | 74.4% | 60% | 51.4% |
| hydrolysis at 95° C./100% RH for 14 days, 23° C./4 mm/11 J | | | |

*C means complete break.

It can be seen from Table 2 that compositions (IE1-IE2) comprising at least one cyclic phosphazene with a high content of trimer cyclic phosphazene (HPCTP, CG-40) have no feeding issue during compounding process even when the content of filler is high, while the composition (CE1) comprising at least one cyclic phosphazene with a low content of trimer cyclic phosphazene (Rabitle® FP-110) has feeding issue.

It can be also seen from Izod unnotched impact strength before and after hydrolysis at 95BC and 100% relative humidity for 3, 5, 7 and 14 days, compositions (5E1-IE2) comprising at least one cyclic phosphazene with a high content of trimer cyclic phosphazene (HPCTP, CG-40) also show better hydrolysis resistance than the composition (CE1) comprising at least one cyclic phosphazene with a low content of trimer cyclic phosphazene (Rabitle® FP-110), even when the content of filler is high.

TABLE 3
Composition and properties of the molding compositions

| Components (parts by weight) | | IE 3 | CE 2 | CE 3 | CE 4 |
|---|---|---|---|---|---|
| A | PC(Makrolon ®2600) | 66.9 | 66.9 | 66.9 | 66.9 |
| B | B1(Elvaloy AC1820) | 5 | | | |
| | B2(SAN DN 50) | | 5 | | |
| | B3(Kane Ace M-732) | | | 5 | |
| | B4 Metablen S 2001 | | | | 5 |
| C | PNZ-2(HPCTP) | 12 | 12 | 12 | 12 |
| D | D1(CS3PE937) | 15 | 15 | 15 | 15 |
| E | E1(ADS 5000) | 0.6 | 0.6 | 0.6 | 0.6 |
| F | F1(Loxiol P 861) | 0.4 | 0.4 | 0.4 | 0.4 |
| | F3(Citric acid) | 0.1 | 0.1 | 0.1 | 0.1 |
| | Feeding issue | No | No | No | No |

Properties

| | | | | |
|---|---|---|---|---|
| Vicat softening temperature, 50N/120K/h, [° C.] | 109 | 110 | 110 | 109 |
| UL 94 V at 0.75 mm | V0 | V0 | V1 | V1 |
| UL 94 V at 1.0 mm | V0 | V0 | V0 | V2 |
| Izod unnotched impact strength, 23° C./4 mm/11 J, [KJ/m²] | 41 C* | 34 C | 39 C | 33 C |
| Izod unnotched impact strength after hydrolysis at | 39 C | 25 C | 24 C | 18 C |
| 95° C./100% RH for 14 days, 23° C./4 mm/11 J, [KJ/m²] | | | | |
| Retention ratio of Izod unnotched impact strength after | 95% | 74% | 62% | 55% |
| hydrolysis at 95° C./100% RH for 14 days, 23°C/4 mm/11 J, | | | | |

*C means complete break.

It can be seen from Table 3 that the composition with component B according to the invention (non-core-shell impact modifier) shows a superior property profile of flame retardancy, impact strength and hydrolysis resistance. CE2 with SAN as component B is inferior with regard to impact strength and retention of impact strength after hydrolysis. CE3 with cores-shell impact modifier (MBS type) as component B is shows a good impact strength but poor retention of impact strength after exposure to moisture. Besides, the flame retardancy at 0.75 mm does not reach the VO classification. If B4 is used (CE 4), hydrolysis and flame retardancy are rather poor.

1. A flame-retardant polycarbonate composition comprising the following components:
A) 50-90 parts by weight of an aromatic polycarbonate,
B) 3-20 parts by weight of a non-core shell impact modifier,
C) 2-15 parts by weight of at least one cyclic phosphazene of formula (V): 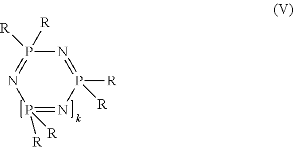
wherein
k is an integer from 1 to 10,
the trimer content (k=1) is more than 98 mol %, based on component C,
and wherein
R are in each case identical or different and are an amine radical, C₁-C₈-alkyl in each case optionally halogenated, C₁-C₈-alkoxy, C₅-C₆-cycloalkyl in each case optionally substituted by alkyl and/or halogen, C₆-C₂₀-aryloxy in each case optionally substituted by alkyl and/or halogen, and/or hydroxyl, C₇-C₁₂-aralkyl in each case optionally substituted by alkyl and/or halogen, a halogen radical, or an OH radical,
D) 0-30.0 parts by weight of a filler,
E) 0.05-5 parts by weight of an anti-dripping agent; and
F) 0-15 parts by weight of additional additives,
wherein the total weight of the composition is 100 parts by weight.

2. Composition according to claim 1, wherein the non-core-shell impact modifier is
selected from ethylene-alkyl (meth)acrylate copolymers of the formula (IV), 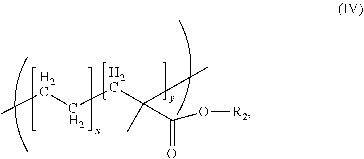
wherein
R₁ is methyl or hydrogen,
R₂ is hydrogen or a C₁-C₁₂-alkyl, preferably methyl, ethyl, propyl, isopropyl, butyl, sec-butyl, tert-butyl, isobutyl, hexyl, isoamyl, or tert-amyl,
each of x and y is an independent degree of polymerization, and
n is an integer >=1.

3. Composition according to claim 1, wherein the trimer content (k=1) is from 98.5 to 100 mol %, based on component C.

4. Compositions according to claim 1, wherein all R=phenoxy.

5. Compositions according to claim 1, wherein the filler is present in the polycarbonate composition in an amount ranging from 0.5 to 30 parts by weight and the filler is selected from the group consisting of mica, talc, wollastonite, barium sulfate, silica, kaolin, titanium dioxide, aluminum hydroxide, magnesium hydroxide, feldspar, asbestos, calcium carbonate, dolomite, vermiculite, attapulgite, bentonite, perlite, pyrophylite, and glass fiber, preferably, the filler is selected from kaolin, talc, wollastonite, and glass fiber.

6. Compositions according to 5, wherein the filler is glass fiber with round cross-section.

7. Composition according to claim 1, wherein the filler is present in an amount ranging from 3 to 26 parts by weight.

8. Compositions according to claim 1, wherein the anti-dripping agent is selected from fluorinated polyolefins.

9. A shaped article produced from the composition according to claim 1.

10. A process for preparing the shaped article according to claim 9, comprising injection moulding, extrusion moulding, blowing moulding or thermoforming the polycarbonate composition according to claim 1.

11. (canceled)

12. Compositions according claim 8, wherein the anti-dripping agent is selected from the group consisting of polytetrafluoroethylene, polyvinylidene fluoride, tetrafluoroethylene/hexafluoropropylene copolymer, and ethylene/tetrafluoroethylene copolymer
